(19) United States
(12) Patent Application Publication
(10) Pub. No.: US 2003/0140096 A1
(43) Pub. Date: Jul. 24, 2003

(54) System and method for providing information and electronic mail and communication services, and related equipment

(76) Inventor: Ferid Allani, Paris (FR)

Correspondence Address: YOUNG & THOMPSON, 745 SOUTH 23RD STREET 2ND FLOOR, ARLINGTON, VA, 22202

(21) Appl. No.: 10/169,356

(22) PCT Filed: Dec. 29, 2000
(86) PCT No.: PCT/FR00/03584

(30) Foreign Application Priority Data
Dec. 30, 1999 (FR) 99/16705

(51) Int. Cl. G06F 15/16

(52) U.S. Cl. 709/203

(57) ABSTRACT

The invention concerns a system for providing information and electronic mail and communications services, comprising in a plurality of local sites, equipment for accessing information sources via one or several communication networks, designed to transmit requests for access to said information sources and to process received data; in one central site, a management server designed to manage access to data sources from equipment installed on the local sites. Each equipment is designed to perform a prior processing of an access request to a data source on the Web, so as to transmit directly the effective Web address of the required data source. Three families of equipment respectively designed for secure places, enclosed spaces and for individuals are provided.

The present invention relates to a system for delivering information and office automation services. It also relates to a method for implementing this system, and apparatuses installed in local sites and included in this system.

An important development in the use of the Internet network in numerous sectors of activity and by private individuals is observed. Due to the multiplication of merchant sited and databases on the Web, professional and private user access remote resources that up to now were not easy to access and electronic trade becomes a major stake.

To access available resources on the Web by Internet, the users presently have at their disposal two types of equipments: the first type of equipment, by far the most wide spread, is constituted by the millions of personal or professional computers and work stations connected to the Web, while the second type of equipments, not still very widespread but in increasing number, is constituted by Internet interactive terminals located on the public lane or in highly frequented places such as commercial centers, airports, railway stations, big hotels or the halls of exhibition or congress centers.

Now, if the personal computers and workstations are usually provided with software and hardware office automation tools permitting to capture and process documents, and to store and print them, and provide the user with ergonomics and a sufficient comfort in use, it is not the same for present interactive terminals that mostly don't offer office automation functions, these terminals being in fact limited in their use to the only functions of access to the Web, of site navigation and consultation, by possibly permitting to print consultation results by thermal printing. Moreover, even if some of these Internet terminals offer graphic interfaces given as user-friendly or propose simplified access portals with predetermined categories, it is noted that users who are not informed Internet surfers meet with difficulties to access searched resources and loose a considerable amount of time for these searches, with the drawback of drastically reducing the number of users.

Furthermore, the interactive terminals presently on the market are conceived with, as a major objective, safety for the equipments confronted with vandalism and damage hazards, and thus are placed into “hardened” caissons offering a minimum of sensitive openings and fragile peripherals, which constitutes an important bar for developing the office automation function.

The aim of the invention is overcome these drawbacks by proposing a system for delivering information and office automation services, that can deal with very varied installation configurations and use profiles, without the constraints that are inherent to equipments intended to be installed on the public lane.

This objective is reached with a system for delivering communication and office automation services comprising:

in a plurality of local sites, apparatuses for accessing information sources through one or more communication networks, comprising means for emitting requests for accessing said information sources, and means for processing received information,

in a central site, a management server arranged for managing access to the information sources from the apparatuses installed in the local sites.

According to the invention, each apparatus installed in a local site further comprises means for making a preliminary process of a request for accessing an information source on the Web, formulated by a user of said apparatus, said preliminary processing means cooperating with said request emitting means, for directly emitting the effective Web address of the searched information source.

Thus, a number of communication and office automation apparatuses, that are easy to use and therefore accessible to any kind o public and users, and can be installed in places as varied as halls of public places, closed spaces in collective, professional or private sites.

The management server of this system is advantageously arranged for selectively transmitting to local apparatuses, through the communication network(s), tools for previously processing requests for accessing information sources. It can also be conceived for doing remote maintenance operations on local apparatuses, for doing secured electronic trade operations on behalf of merchant sites or for managing on-line advertising operations aimed to lots of selected apparatuses.

According to another aspect of the invention, a method for delivering information and office automation services, implemented in the system according to the invention, is proposed, comprising:

in a plurality of local sites, sequences for emitting requests for accessing information sources from apparatuses connected to one or more communication networks, apparatuses for accessing information sources through one or more communication networks, and sequences for processing received information,

in a central site, managing accesses to the information sources from the apparatuses installed in the local sites, characterized in that it further comprises a prior processing for requests for accessing an information source on the Web, formulated by a user of said apparatus, this prior processing leading to directly emitting the effective Web address of the searched information source.

According to another aspect of the invention, a communication and office automation apparatus is proposed, implemented in a system for delivering information and office automation services according to the invention, said apparatus comprising means for emitting request for accessing remote information sources, means for processing documents under electronic or paper form, and means for processing information received from said remote sources, characterized in that it further comprises means for making a prior processing for a request for accessing an information source on the Web, these prior processing means cooperating with the request emitting means, for directly emitting the effective Web address of the searched information source.

This communication and office automation apparatus can further comprise means for managing a selective access to the communication and office automation means.

The communication means can advantageously be provided as comprising radio-communication or mobile communication means. Information exchanged with the information sources can then be transmitted according to wireless access protocol such as the WAP protocol or any other communication protocol available in the context of Internet, especially for the communication networks of the UMTS type.

A first family of communication and office automation apparatuses according to the invention, named as INDESK™, concerns apparatuses installed in public or private secured enclosures, such as airports, halls of administrations or congress or exhibition rooms. As these apparatuses are not installed on public lanes, they can include equipments such as colour printers, and not thermal printers as observed on apparatuses installed on public lanes. They can be provided with a caisson that is less strong and strengthened than for apparatuses on the public lane because they are less exposed to vandalism acts. Personalized dressings can also be considered in function of the feature of the places wherein they are installed.

A second family of communication and office automation apparatuses according to the invention, named as ROOMDESK™, concerns apparatuses intended to be installed in closed spaces such as rooms, saloons, in hotels, communities, homes and residences. These apparatuses can include television equipments that can be used as monitors for the functions of communication on Internet and for the office automation functions. They can also get a personalized dressing, for example with the colours of the hotels that are equipped with said apparatuses or with a style and a decoration that are compatible with the room wherein they are installed.

A third family of communication and office automation apparatuses according to the invention, named as HOMEDESK™, concerns apparatuses with the same structure as the apparatuses of the ROOMDESK™ type, but intended to be installed for private individuals, craftsmen, independent professionals, small or medium size companies, for private or professional use.

Other particularities and advantages of the invention will become apparent in the following description. To the attached drawings given as way of non-limitative examples:

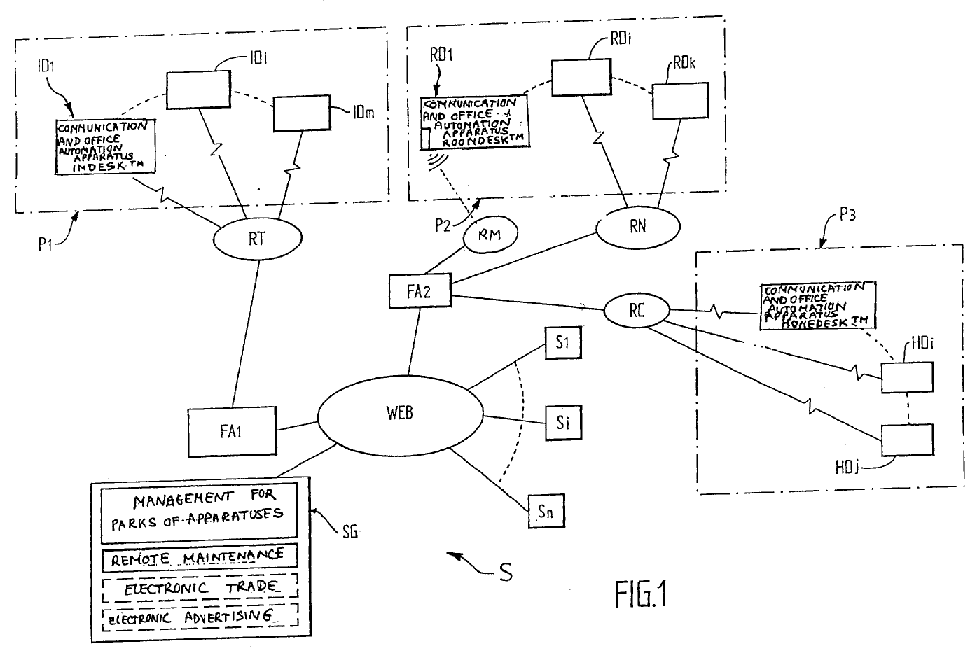

FIG. 1 is a synoptic scheme of an example of embodiment of a system for delivering communication and office automation services according to the invention,

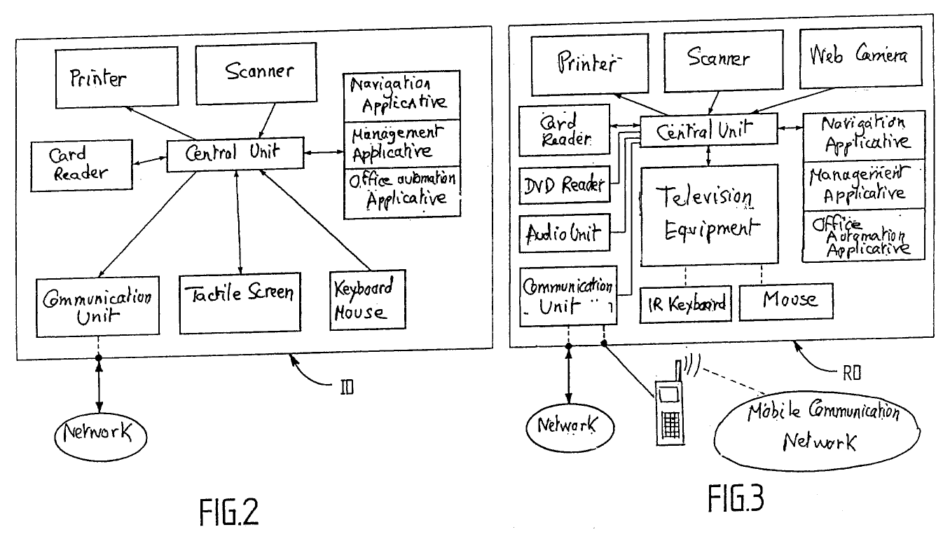

FIG. 2 illustrates a first schematic example of an internal structure for an communication and office automation apparatus according to the invention, intended to secured public or semi-public places (INDESK™), and

FIG. 3 illustrates a second schematic example of an internal structure for a communication and office automation apparatus according to the invention, intended to closed spaces (ROOMDESK™ or HOMEDESK™).

An example of embodiment of a system for delivering communication and office automation services will now be described, with reference to FIG. 1, at the same time as the working of said system and of communication and office automation apparatuses equipping said system.

This system S comprises, in a central site, a management server SG connected to the Web and, in a plurality of local sites, communication and office automation apparatuses also connected to the Web through telecommunication networks and access providers.

The management server includes for example modules for managing parks of apparatuses, modules for remote maintenance of the apparatuses, and modules for electronic trade and selective diffusion of electronic advertisements.

In the described example, the system according to the invention includes:

a first park P1 of apparatuses ID1, . . . ,Idi, . . . Idm installed in enclosures or public sites that are secured or under surveillance, therefore excluding the public lane,

a second park P2 of apparatuses RD1, .. . ,Rdi, . . . ,RDk installed in closed spaces such as hotel rooms or saloons, and

a third park P3 of apparatuses HD1, . . .,Hdi, . . . HDj installed at private individuals or professionals.

For example, the apparatuses of the park P1 can be conceived as being connected to the Web through a first communication network, for example the commutation phone network, and through a first access provider FA1 linked or not to the operator of the management server. The apparatuses of the park P2 can be connected to the Web by a second access provider FA2 either through a second communication network RN, for example a Integrated Service Digital Network (ISDN or RNIS) or through a wireless communication network RM such as a GSM or UMTS network with the implementation of a communication protocol adapted to the network in use, for example the WAP protocol. The communication and office automation apparatuses connected by this way can directly include a wireless communication module and the software functions associated with the communication protocol in use, or can be connected to a mobile phone adapted to manage this protocol.

The apparatuses of the park P3 are for example connected to the Web through a third communication network RC and through the second access provider FA2.

More generally, all the combinations of connection for the parks of apparatuses can be considered, from a unique configuration common to the whole apparatuses whatever the park the apparatuses belong to, to configurations that are completely independent and partitioned for each park, along with hybrid solutions such the one that has been described with reference to FIG. 1. The use of a management server for each park of apparatuses can also be considered.

Each apparatus from either of these three parks or families of apparatuses comprises the following common components:

a central unit card,

one or more data storage units,

a unit of communication and connection to the Web,

a user interface, for example of tactile screen type that permits to both capture commands and data and display information,

a printing equipment,

a document digitizing equipment.

Each apparatus receives a set of software comprising:

an applicative software intended to, on one hand, manage the information processing and office automation functions, and, on the other hand, manage the functions of communication on the Web and the exchanges with the management server,

one or more navigation software, and

conventional or dedicated office automation software.

A feature of the applicative software installed in the apparatuses according to the invention lies in the fact that these software are conceived to achieve a preliminary processing for requests emitted by the users so as to directly emit the Web address corresponding the relevant information source. The question is thus to limit the number of go-and-returns “request/reception” that are tedious and time-consuming between the consultation station and the servers S1, . . . ,Si, . . . ,Sn.

This local preliminary processing can present various forms, such as locally storing a data base containing a set of relevant links associated with a set of key-words, or can use for example a set of unrolling menus according to a new method that is the subject matter of a patent application simultaneously filed.

Numerous optional configurations, both software and hardware, can be considered for each family of apparatuses.

As a way of non-limitative examples, two particular configurations of apparatuses according to the invention will now be described.

A first configuration ID, represented in FIG. 2, corresponding to apparatuses of the INDESK™ type, includes a central unit, a colour printer, a scanner, a payment card reader, a communication unit including for example a modem, a tactile screen, an integrated keyboard-mouse set, and storage units, such as a hard disk and/or a CD-ROM, receiving a navigation applicative implementing the function of preliminary request processing, an applicative for managing the different components of the apparatus, and conventional office automation applicative such as word processing or spreadsheet.

In a second configuration RD represented in FIG. 2 and corresponding to an apparatus belonging to the family of apparatuses of the ROOMDESK™ or HOMEDESK™ type, the apparatus includes a central unit, a colour printer, a scanner, a Web camera, a payment card reader, a complete equipment of digital television, a DVD reader, au audio unit comprising acoustic speakers, a keyboard and an infrared mouse, and storage units, such as a hard disk and/or a CD-ROM, receiving a navigation applicative, a management applicative and office automation applicative. This configuration, more particularly intended to private individual or professional clients, permits, in addition to the above-cited functions of access to Internet resources and office automation, uses of the WebTV™ type and “Home Cinema” uses. This apparatus can be connected to a management server via an access provider either through a wired communication network, or through a radio-communication network or a mobile communication network via a mobile phone equipment connected to the apparatus, for example a GSM-type network, with the possibility to use the WAP (Wireless Access Protocol) protocol or dedicated protocols associated with communication networks of the UMTS type.

It has to be noted that the use of a radio-communication technology with Internet communication protocols can be proposed for the whole communication and office automation apparatuses according to the invention. Moreover, a communication and office automation apparatus according to the invention can be provided as directly integrating a radio-communication or wireless communication module, without requiring a connection to a external mobile communication equipment.

Moreover, even if the communication and office automation apparatuses according to the invention have been essentially described in a context of parks of apparatuses managed from a management server, in fact these apparatuses can be used each independently since they include the whole necessary means for communication with information sources on the Web, and means for processing documents under electronic or paper form.

Of course, the invention is not limited to the examples that have been described and numerous adjustments can be made to these examples without departing from the scope of the invention. Thus, the integration of other equipments and peripherals for office automation, communication or electronic payment within apparatuses according to the invention can be easily considered. Moreover, other families of apparatuses than those that have been described can be considered in function of the evolution of the needs and the pubic concerned by this type of apparatus.

1. A system (S) for delivering communication and office automation services, comprising:
in a plurality of local sites, apparatuses (ID, RD, HD) for accessing information sources (S1, . . . ,Si, . . . ,Sn) through one or more communication networks (RT, RN, RC), comprising means for emitting requests for accessing said information sources, and means for processing received information,
in a central site, a management server (SG) arranged for managing access to the information sources from the apparatuses installed in the local sites,
characterized in that each apparatus installed in a local site further comprises means for making a preliminary process of a request for accessing an information source on the Web, formulated by a user of said apparatus, said preliminary processing means cooperating with said request emitting means, for directly emitting the effective Web address of the searched information source.

2. The system (S) for delivering information and office automation services according to claim 1, characterized in that the management server (SG) is arranged for selectively transmitting to local apparatuses, through the communication network(s), tools for previously processing requests for accessing information sources.

3. The system (S) for delivering information and office automation services according to any of claims 1 or 2, characterized in that the management server is arranged for doing remote maintenance operations on local apparatuses.

4. The system for delivering information and office automation services according to any of claims 1 to 3, characterized in that the management server is arranged to deliver electronic trade services.

5. A method for delivering information and office automation services, implemented in the system according to any of claims 1 to 4, comprising:
in a plurality of local sites, sequences for emitting requests for accessing information sources from apparatuses connected to one or more communication networks, apparatuses for accessing information sources through one or more communication networks, and sequences for processing received information,
in a central site, managing accesses to the information sources from the apparatuses installed in the local sites,
characterized in that it further comprises a prior processing for requests for accessing an information source on the Web, formulated by a user of said apparatus, this prior processing leading to directly emitting the effective Web address of the searched information source.

6. A communication and office automation apparatus, implemented in a system for delivering information and office automation services according to any of claims 1 to 4, said apparatus comprising
communication means, means for processing documents under electronic or paper form, means for emitting requests for accessing remote information sources through one or more communication networks to which the communication means are connected, and means for processing information received from said sources, characterized in that it further comprises means for doing a prior processing of a request for accessing an information source on the Web, these prior processing means cooperating with the request emitting means, for directly emitting the effective Web address of the searched information source.

7. The communication and office automation apparatus according to claim 6, characterized in that it further comprise means for managing a selective access to the communication means and to the document processing means.

8. The communication and office automation apparatus according to any of claims 6 or 7, characterized in that the communication means comprises radio-communication or mobile communication means.

9. The communication and office automation apparatus according to claim 8, characterized in that the information exchanged with the information sources are transmitted according to wireless access protocol such as the WAP protocol.

10. The communication and office automation apparatus according to any of claims 6 to 9, characterized in that is arranged to be installed in public or private secured enclosures.

11. The communication and office automation apparatus according to any of claims 6 to 9, characterized in that it is arranged to be installed in closed spaces.

12. The communication and office automation apparatus according to any of claims 6 to 11, characterized in that it includes a television equipment.

13. The communication and office automation apparatus according to claim 12, characterized in that the television equipment is used as an display interface for the communication and office automation functions.

14. The communication and office automation according to any of claims 6 to 13, characterized in that it is conceived to be used in a private or professional place.
